(19) United States
(12) Patent Application Publication
(10) Pub. No.: US 2017/0131544 A1
(43) Pub. Date: May 11, 2017

(54) Crystal Clear Glass

(71) Applicants: Jonathan Chester, Smithfield, PA (US); Calvin Heagy, Meadville, PA (US)

(72) Inventors: Jonathan Chester, Smithfield, PA (US); Calvin Heagy, Meadville, PA (US)

(21) Appl. No.: 14/934,892

(22) Filed: Nov. 6, 2015

(51) Int. Cl. G02B 27/00; H04M 1/02; H04B 1/3888; G02B 7/00

(52) U.S. Cl. CPC G02B 27/0025; G02B 7/00; H04M 1/0202; H04B 1/3888

(57) ABSTRACT

This invention relates to a prescription strength screen cover that removablly covers the screen of a smartphone or like and a life proof or outer box style case inside which the screen is spring loaded in place. The prescription strength screen is made from tempered glass. The prescription strength screen cover eliminates the need for a user to wear vision-correction articles, such as eye glasses or contact lenses, to view the display screen of a smartphone or like. The case protects the smartphone from water, dust and fall.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

(1) Field of the Invention

The present invention relates to the field of devices having personalized refractive power capabilities. The invention, particularly relates to display screen cover having personalized refractive power capability.

(2) Background of the Invention

There exist various optical devices for placement with respect to a display screen such as a computer monitor in order to magnify or filter the image on the monitor. However, many of these devices are difficult to correctly position and do not account for other refractive errors. Additionally, when viewing such display screens, individuals with refractive error are required to wear vision-correction articles to improve the individuals' vision of the display screens.

A number of different types of devices having personalized refractive power capabilities are present in prior art. For example, see: U.S. patent application Ser. No. 11/731,652 to Scott et al; U.S. patent application Ser. No. 12/794,022 to Jeffrey; U.S. patent application Ser. No. 13/185,849 to Zidan et al; U.S. patent application Ser. No. 14/312,516 to Atsushi; U.S. Pat. No. 7,657,394 to Alan; U.S. Pat. No. 8,074,181 to Zaman et al; U.S. Pat. No. 8,605,082 to Brian.

U.S. patent application Ser. No. 12/794,022 discloses methods and systems for forming personalized display screen covers and the resulting covers produced therefrom. The display screen covers that include personalized refractive power capabilities corresponding to users' refractive error prescriptions. The display screen covers may be configured to releasably adhere to display screens of electronic devices, such as clinging to screens owing to static electricity.

Another prior art, U.S. Pat. No. 7,657,394 discloses a magnification device for a display screen of an electronic device that can be selectively sized to fit directly thereon. The magnification device is of a thin, flexible synthetic resin sheet having distributed magnification and static adhesion properties that can easily be cut to size to fit the display screen venue to be magnified.

Another prior art, U.S. patent application Ser. No. 11/731,652 discloses a magnifying sheet with an adhesive layer that is dimensioned to fit on a variety of display screens for computers, cell phones, personal digital assistants, game boys, blackberries and a variety of other electronic equipment. The invention utilizes a thin, transparent plastic sheet with magnifying capabilities that has an adhesive layer with a backing to permit it to be easily attached to a display screen.

Accordingly, there remains a need for improved and/or alternative for providing a display screen cover having personalized refractive power capabilities so that users may avoid wearing vision-correction articles. The present disclosure is addressed to those needs.

### SUMMARY OF THE INVENTION

In the view of the foregoing disadvantages inherent in the known types of devices having personalized refractive power capabilities now present in the prior art, the present invention provides a display screen cover having personalized refractive power capability. As such, the general purpose of the present invention, which will be described subsequently in greater detail, is to provide a display screen cover which has all the advantages of the prior art and none of the disadvantages.

An object of the invention is to provide a prescription strength screen cover that removablly covers the screen of a smartphone or like.

It is another object of the present invention to provide a life proof or outer box style case inside which the screen is spring loaded in place.

It is another object of the present invention to provide a prescription strength screen made from tempered glass.

It is another object of the present invention to provide prescription strength screen cover that eliminates the need for a user to wear vision-correction articles, such as eye glasses or contact lenses, to view the display screen of a smartphone or like.

It is another object of the present invention to provide the case that protects the smartphone from water, dust and fall.

It is another object of the present invention to provide life proof case and screen cover that protects integrity and overall function of the device.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG.1 shows the perspective view of a display screen cover according to an embodiment of the present disclosure.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description is, therefore, not to be taken in a limiting sense, and the scope of the present invention is defined by the appended claims and their equivalents.

In certain aspects, the present invention provides display screen cover having personalized refractive power capability and a life proof or outer box style case. The cover may be configured to removablly adhere to a display screen of an electronic device for example smartphone or like. Additionally, the personalized refractive power capability of the cover corresponds to the particular users' refractive error prescriptions.

In this way, the cover enhances each user's vision of a corresponding display screen and, in certain situations, can eliminate the need for the user to wear vision-correction articles, such as eye glasses or contact lenses, to view the display screen.

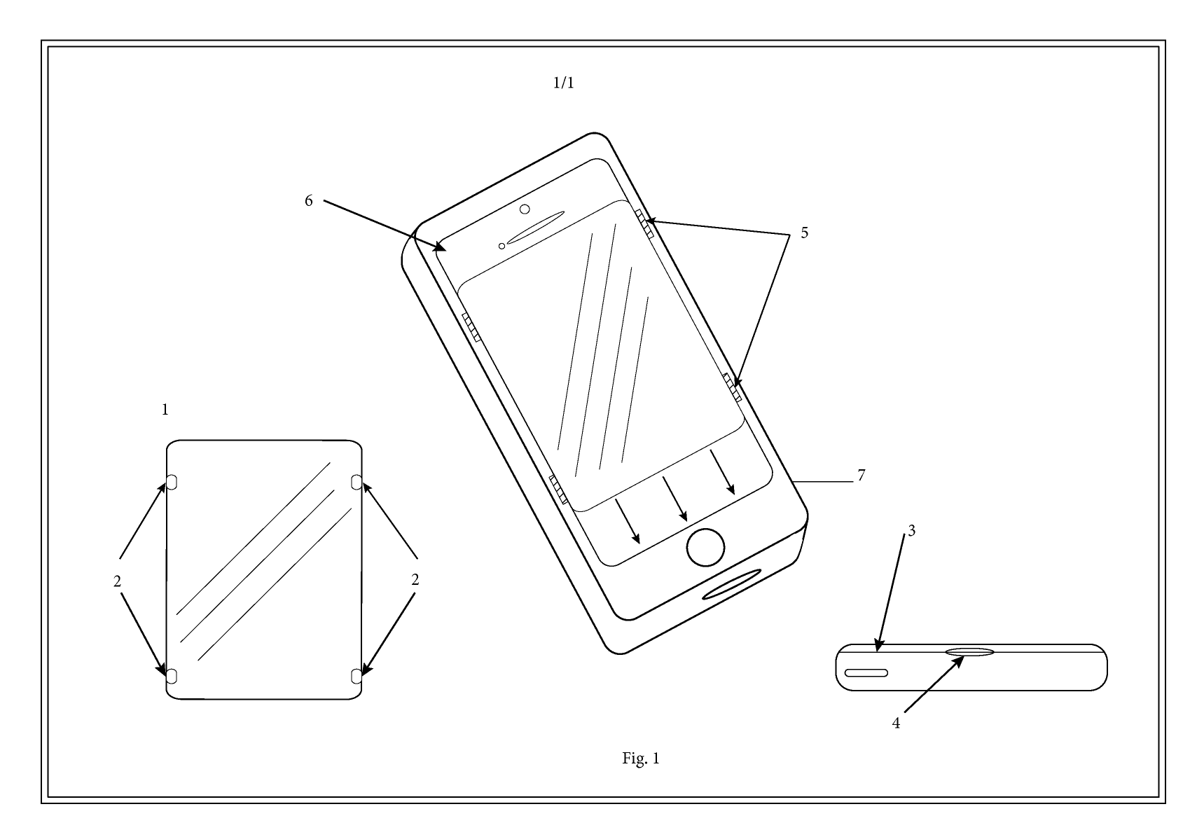

On referring FIG. 1 shows preferred embodiment of the present invention. The figure shows a prescription strength glass or plastic cover 1 with catches 2 for spring loaded hooks to hold in glass. The figure also shows top view of a hand held device for example a smartphone 7 whose display or touchscreen 6 is covered by prescription strength or corrective lens screen cover 1. The screen cover is held on top of the display of the smartphone using spring loaded catches 5. The figure further shows a slot 3 for the screen cover 1 to slide into. The figure also shows a finger press 4 to release spring load screen cover holder.

In certain embodiments, the display screen cover contemplated by the present disclosure has a relatively small thickness, the cover being sufficiently thin that a necessary amount of illumination from the display screen penetrates through the cover.

Additionally, the display screen cover may be configured to removablly adhere to a display screen to allow for selective, temporary application. In preferred embodiments, the screen cover is made of tempered glass and is spring loaded in place inside the life proof or outer box style case. There is another spring loaded slot in the back of the case where the screen cover can sit when not in use. It is contemplated that the cover may removablly adhere to a display screen in a variety of other appropriate manners as would occur to one of ordinary skill in the art.

The case is designed to protect the phone from water, dust and fall. The spring loaded piece that holds in the glass will also help with easy removal. The corrective lens screen cover takes away the need or use of glasses while using the device. The case and the display screen cover protect the integrity and overall function of the device. The case is made up of plastic material or the like.

In another embodiment the current invention may also be made for those users, who just use reading glasses, so that it may be readily available to them while shopping.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

We claim:

1. An apparatus that eliminates use of glasses or contact lens, comprising:
a screen cover and a case.

2. The apparatus that eliminates use of glasses or contact lens according to claim 1, wherein said screen cover is prescription strength screen cover.

3. The apparatus that eliminates use of glasses or contact lens according to claim 2, wherein said screen cover covers display screen of a smartphone or like.

4. The apparatus that eliminates use of glasses or contact lens according to claim 1, wherein said case is a life proof or outer box style case.

5. The apparatus that eliminates use of glasses or contact lens according to claim 4, wherein spring loaded slots are present on a front surface of said case.

6. The apparatus that eliminates use of glasses or contact lens according to claim 4, wherein spring loaded slots are present on a back surface of said case.

7. The apparatus that eliminates use of glasses or contact lens according to claim 1, wherein said screen cover is spring loaded on front surface, inside said case.

8. The apparatus that eliminates use of glasses or contact lens according to claim 1, wherein said screen provides for refractive power corresponding to the averaged refractive error prescription for both eyes of a user.

9. The apparatus that eliminates use of glasses or contact lens according to claim 1, wherein said screen cover is a prescribed removable piece of tempered glass.

10. The apparatus that eliminates use of glasses or contact lens according to claim 1, wherein said case is made up of plastic or like.

11. The apparatus that eliminates use of glasses or contact lens according to claim 1, wherein said case protects the smartphone or like form water, dust and fall.
